(19) United States
(12) Patent Application Publication
(10) Pub. No.: US 2025/0175569 A1
(43) Pub. Date: May 29, 2025

(54) SCANNER, NON-TRANSITORY COMPUTER READABLE RECORDING MEDIUM STORING COMPUTER-READABLE INSTRUCTIONS FOR SCANNER, AND METHOD EXECUTED BY SCANNER

(71) Applicant: BROTHER KOGYO KABUSHIKI KAISHA, Nagoya (JP)

(72) Inventor: Akihito UNO, Iwakura (JP)

(21) Appl. No.: 18/932,920

(22) Filed: Oct. 31, 2024

(30) Foreign Application Priority Data
Nov. 29, 2023 (JP) 2023-201625

(51) Int. Cl. H04N 1/44; H04N 1/00

(52) U.S. Cl. CPC H04N 1/4426; H04N 1/00106; H04N 1/00307

(57) ABSTRACT

A scanner may receive a scan instruction from a first terminal device, cause a scan executing unit to scan a document and acquire scan image data and acquire first user identification information corresponding to the scan instruction. The scanner may, after the scan instruction has been received from the first terminal device, receive an image request from a second terminal device and acquire second user identification information corresponding to the image request. The scanner may, in a case where the first user identification information and the second user identification information match, send the scan image data to the second terminal device.

### REFERENCE TO RELATED APPLICATION

This application claims priority to Japanese Patent Application No. 2023-201625 filed on Nov. 29, 2023. The entire content of the priority application is incorporated herein by reference.

### BACKGROUND ART

A system with an information processing device and an image forming device is known. When the image forming device receives a scan request from the information processing device, the image forming device sends a signal, to the information processing device, to request authentication information to be sent. When the image forming device receives the authentication information from the information processing device, the image forming device executes an authentication process using the received authentication information. When the authentication process is successful, the image forming device executes a scanning process.

### SUMMARY

The present specification provides a novel technique for properly sending scan image data.

The present teachings disclose a scanner. The scanner may comprise: a scan executing unit; and a controller configured to: receive a scan instruction from a first terminal device; in a case where the scan instruction is received from the first terminal device, cause the scan executing unit to scan a document and acquire scan image data; in the case where the scan instruction is received from the first terminal device, acquire first user identification information corresponding to the scan instruction; after the scan instruction has been received from the first terminal device, receive an image request from a second terminal device; in a case where the image request is received from the second terminal device, acquire second user identification information corresponding to the image request; and in a case where the first user identification information and the second user identification information match, send the scan image data to the second terminal device.

According to the above configuration, the scanner sends the scan image data to the second terminal device in the case where the first user identification information corresponding to the scan instruction and the second user identification information corresponding to the image request match. Thus, the scanner can send the scan image data appropriately.

A computer-readable instructions for realizing the above scanner, a computer-readable storage medium storing the above-described computer-readable instructions, and a method executed by the scanner are also new and useful. Also, a communication system comprising the scanner, the first terminal device, and the second terminal device that are described above is also novel and useful.

### BRIEF DESCRIPTION OF DRAWINGS

FIG. 1 shows a configuration of a communication system.

FIG. 2 shows a sequence diagram of a registration process.

FIG. 3 shows a sequence diagram of a process before scanning.

FIG. 4 shows a flowchart of a scanning process executed by a scanner.

FIG. 5 shows a sequence diagram of Case A in which a scan is executed.

FIG. 6 shows a sequence diagram of Case B in which a scan is executed.

FIG. 7 shows a sequence diagram of Case C in which the execution of a scan is cancelled.

### DESCRIPTION

### Embodiment

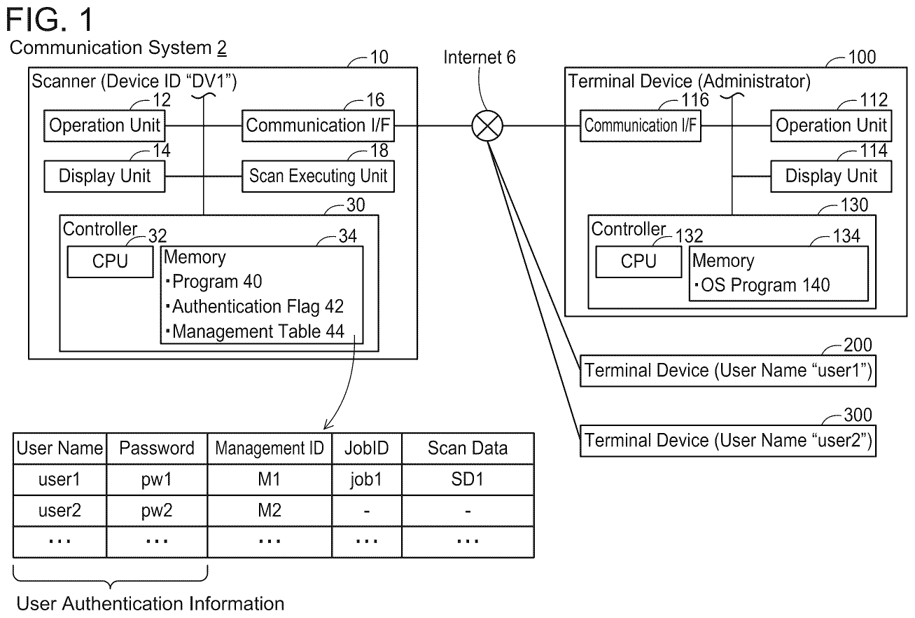

### Configuration of Communication System 2; FIG. 1

As shown in FIG. 1, a communication system 2 comprises a scanner 10 and a plurality of terminal devices 100, 200, 300. The scanner 10 and each of the terminal devices 100, 200, 300 are connected to the Internet 6. Each of the devices 10, 100, 200, 300 is configured to communicate with each other via the Internet 6.

### Configuration of Scanner 10

The scanner 10 is a peripheral device configured to execute a scan function. The scanner 10 is also configured to execute a web server function. The web server function is a function that sends web page data representing a web page to an external device in response to the external device accessing a web server in the scanner 10. In a modification, the scanner 10 may further be a multifunction peripheral configured to execute a print function, a fax function, for example. The scanner 10 has a device ID “DV1”. The device ID is a name assigned by an administrator of the scanner 10. The scanner 10 comprises an operation unit 12, a display unit 14, a communication interface 16, a scan executing unit 18, and a controller 30. In the following, the interface will be described as “I/F”.

The operation unit 12 is an I/F that allows the user to input various information to the scanner 10. The operation unit 12 comprises hardware key(s), software key(s) (object(s)), or both. For example, the operation unit 12 includes a touch screen, button(s), or both. The display unit 14 is a display or panel for showing various information. The panel may or may not be a touch screen. The panel may be, for example, an LCD panel or an organic EL panel. The communication I/F 16 is connected to the Internet 6. The communication I/F 16 may be a wired I/F or a wireless I/F.

The scan executing unit 18 comprises a scanner engine with an image sensor such as a Charge-Coupled Device (CCD) image sensor or a Contact Image Sensor (CIS).

The controller 30 comprises a CPU 32 and a memory 34. The memory 34 includes a primary storage device and an auxiliary storage device. The CPU 32 executes various processes according to a program 40 stored in the auxiliary storage device of the memory 34. Specifically, the CPU 32 executes the various processes described above by loading the program 40 from the auxiliary storage device to the primary storage device and executing said program 40. The primary storage device is, for example, a RAM and cache memory. The auxiliary storage device may be, for example, a flash memory, a Solid State Drive (SSD), or a ROM, or a combination thereof. The memory 34 further stores an authentication flag 42 and a management table 44. The authentication flag 42 indicates either “ON”, indicating that execution of scanning using user authentication is requested, or “OFF”, indicating that the execution of scanning using user authentication is not requested. The authentication flag 42 is set by the administrator of the scanner 10.

The management table 44 is a table for managing information for executing scanning using user authentication. In the management table 44, a user name, a password, a management ID, a JobID, and scan data are stored in association with each other. In the following, the user name and the password may be collectively referred to as “user authentication information.” The management ID is information generated by the scanner 10 and is for managing the user authentication information. The JobID is information for identifying the scan data.

### Configuration of Terminal Devices 100, 200, 300

The terminal device 100 is a terminal device such as a cell phone (e.g., smartphone), a PDA, a tablet PC, a desktop PC, or a laptop PC, for example. The terminal device 100 is a terminal device used by the administrator of the scanner 10. The terminal device 100 comprises an operation unit 112, a display unit 114, a communication I/F 116, and a controller 130.

The operation unit 112 is an I/F that allows the user to input various information to the terminal device 100, and comprises a touch screen, button(s), or both, for example. The display unit 114 is a display or a panel for displaying various information. The panel may or may not be a touch screen. The panel may be, for example, an LCD panel or an organic EL panel. The communication I/F 116 is connected to the Internet 6.

The controller 130 comprises a CPU 132 and a memory 134. The memory 134 comprises a primary storage device and an auxiliary storage device. An OS program 140 is stored in the auxiliary storage device of the memory 134. The OS program 140 controls basic operations of the terminal device 100. The CPU 132 realizes various processes according to a program loaded from the auxiliary storage device to the primary storage device.

The terminal devices 200 and 300 have the same configuration as the terminal device 100. The terminal devices 200 and 300 are terminal devices used by a user different from the administrator.

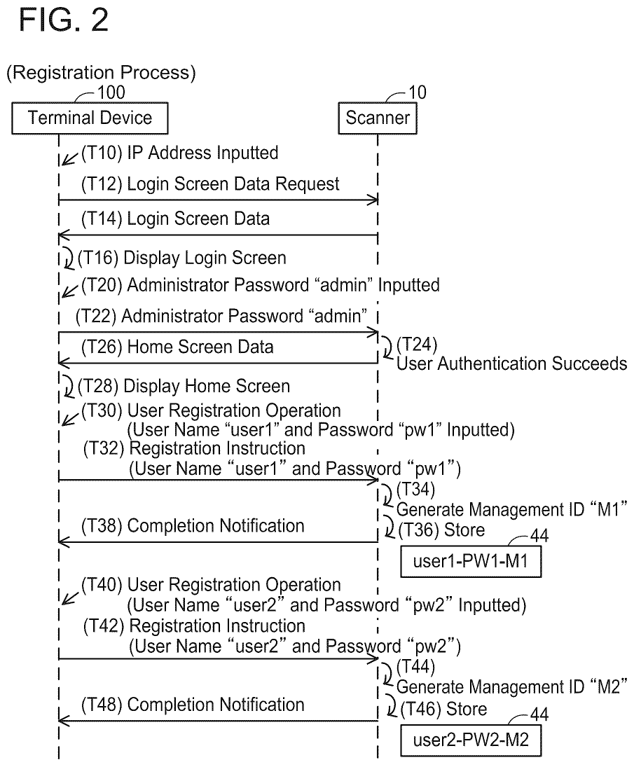

### Registration Process; FIG. 2

With reference to FIG. 2, a registration process for registering the user authentication information to the scanner 10 will be described. At an initial state in FIG. 2, the management table 44 of the scanner 10 is empty. The memory 34 of the scanner 10 stores an administrator password “admin” for accessing the web server in the scanner 10. In FIG. 2, contents of processes will be described with each device (e.g., scanner 10, etc.) as a subject of action, instead of describing the CPU of each device (e.g., CPU 32) as a subject of action.

In T10, the administrator inputs an IP address of the scanner 10 to the terminal device 100. In T12, the terminal device 100 sends a login screen data request to the scanner 10 with the inputted IP address as its destination, in T14, receives the login screen data from the scanner 10, and in T16, displays a login screen represented by the login screen data. The login screen includes an area for inputting the administrator password. In T20, the administrator performs an operation to input the administrator password “admin” into the terminal device 100. Due to this, in T22, the terminal device 100 sends the administrator password “admin” to the scanner 10.

In T22, the scanner 10 receives the administrator password “admin” from the terminal device 100, and in T24, determines that user authentication has succeeded because the received administrator password “admin” and the administrator password “admin” in the memory 34 match. In this case, in T26, the scanner 10 sends home screen data to the terminal device 100.

In T26, the terminal device 100 receives the home screen data from the scanner 10, and in T28, displays a home screen represented by the home screen data. The home screen is a screen used to change settings of the scanner 10 and to register the user authentication information to the scanner 10.

In T30, the administrator performs a user registration operation, on the terminal device 100, to input a user name “user1” and a password “pw1” into the terminal device 100. Due to this, in T32, the terminal device 100 sends a registration instruction including the user name “user1” and the password “pw1” to the scanner 10. The user name “user1” and the password “pw1” are the user authentication information corresponding to a user of the terminal device 200.

When the scanner 10 receives the registration instruction from the terminal device 100 in T32, in T34 the scanner 10 generates a management ID “M1” corresponding to the user name “user1” and the password “pw1”. Next, in T36, the scanner 10 stores the user name “user1”, the password “pw1”, and the management ID “M1” in association with each other in the management table 44, and in T38, the scanner 10 sends a completion notification indicating that the user registration is completed to the terminal device 100.

T40 to T48 are the same as T30 to T38, except that a user name “user2”, a password “pw2”, and a management ID “M2” are used instead of the user name “user1”, the password “pw1”, and the management ID “M1”. Due to this, the user name “user2”, the password “pw2”, and the management ID “M2” are stored in association with each other in the management table 44. The user name “user2” and the password “pw2” are the user authentication information corresponding to a user of the terminal device 300. In this way, the user authentication information is registered in the management table 44 of the scanner 10.

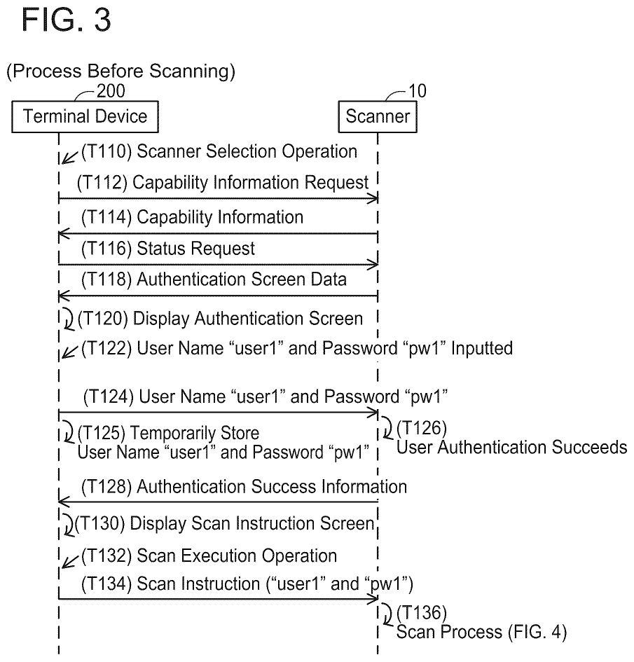

### Process Before Scanning; FIG. 3

With reference to FIG. 3, a process before scanning for sending a scan instruction to the scanner 10 will be described. An initial state of FIG. 3 is after FIG. 2. The authentication flag 42 of the scanner 10 is set to “ON”.

In T110, the user of the terminal device 200 performs a scanner selection operation, on the terminal device 200, to select the scanner 10 as a scanner to execute the scan function. Due to this, in T112, the terminal device 200 sends a capability information request to the scanner 10. The capability information request is a signal to request the scanner 10 to send capability information regarding function(s) that the scanner 10 is configured to execute. The information regarding the function(s) that the scanner 10 is configured to execute is, for example, a resolution and a data format that can be converted.

When the scanner 10 receives the capability information request from the terminal device 200 in T112, in T114 the scanner 10 sends the capability information of the scanner 10 to the terminal device 200.

When the terminal device 200 receives the capability information from the scanner 10 in T114, in T116 the terminal device 200 sends a status request to the scanner 10. The status request is a signal to check the status of the scanner 10 and also to confirm whether or not user authentication is required.

When the scanner 10 receives the status request from the terminal device 200 in T116, the scanner 10 determines that the scanner 10 is in a standby state and that the authentication flag 42 is set to “ON”, and in T118, sends authentication screen data to the terminal device 200.

When the terminal device 200 receives the authentication screen data from the scanner 10 in T118, in T120, the terminal device 200 displays an authentication screen represented by the authentication screen data. The authentication screen data includes an area for inputting a user name and a password. In T122, the user of the terminal device 200 performs an operation to input the user name “user1” and the password “pw1” on the terminal device 200. Due to this, in T124, the terminal device 200 sends the user name “user1” and the password “pw1” to the scanner 10. In T125, the terminal device 200 temporarily stores the user name “user1” and the password “pw1” in the memory of the terminal device 200. For example, the terminal device 200 stores the user name “user1” and the password “pw1” in the primary storage device of said memory.

When the scanner 10 receives the user name “user1” and the password “pw1” from the terminal device 200 in T124, in T126 the scanner 10 determines that the user authentication has succeeded because the user name “user1” and the password “pw1” are stored in the management table 44. In this case, in T128 the scanner 10 sends authentication success information to the terminal device 200. In a case where the scanner 10 receives the status request from the terminal device 200 while the authentication flag 42 is set to “OFF” (see T116), the scanner 10 sends scan instruction screen data representing a scan instruction screen to the terminal device 100. That is, in a case where the authentication flag 42 is set to “OFF”, T118 to T128 are omitted.

When the terminal device 200 receives the authentication success information from the scanner 10 in T128, in T130 the terminal device 200 displays the scan instruction screen. The scan instruction screen is a screen for setting scan settings to be used when executing the scan function. In T132, the user performs a scan execution operation on the terminal device 200, to cause the scanner 10 to execute the scan function. Due to this, the terminal device 200 specifies the user name “user1” and the password “pw1” stored in the memory of the terminal device 200 (see T125), and in T134, the terminal device 200 sends the scan instruction including the user name “user1” and the password “pw1” to the scanner 10.

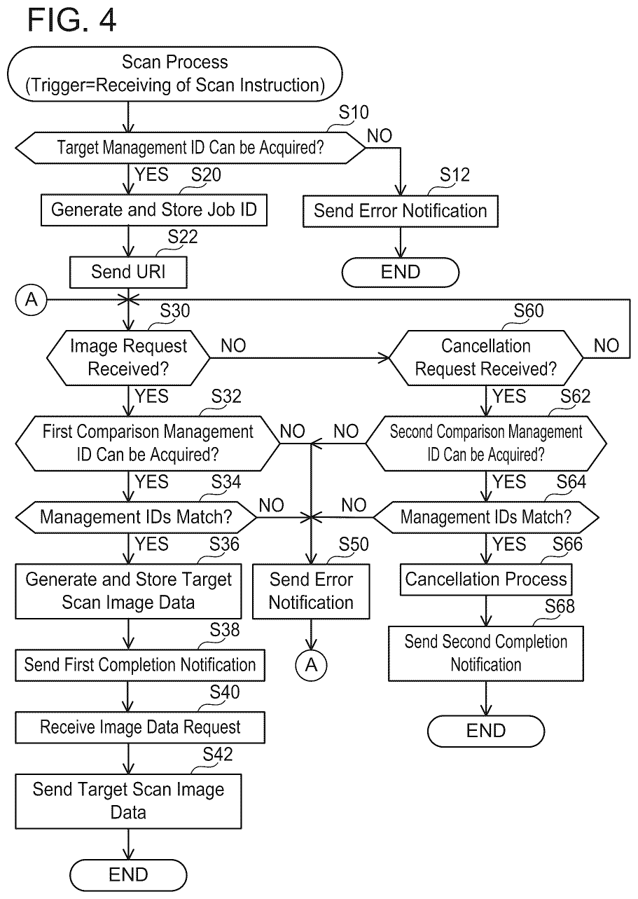

When the scanner 10 receives the scan instruction from the terminal device 200 in T134, in T136 the scanner 10 executes the scan process (see FIG. 4). The scan process is a process for executing the scan function.

### Scan Process; FIG. 4

With reference to FIG. 4, the scan process executed by the CPU 32 of the scanner 10 will be described. As described above, the CPU 32 executes processes shown in FIG. 4 in the case where the scan instruction is received from the terminal device. In the following, the terminal device that is the sender of the scan instruction will be described as “first target terminal device,” the terminal device that is the sender of an image request (see S30) described below will be described as “second target terminal device,” and the terminal device that is the sender of a cancellation request (see S60) described below will be described as “third target terminal device”.

In S10, the CPU 32 determines whether a management ID corresponding to the first target terminal device (hereinafter referred to as “target management ID”) can be acquired or not. Firstly, the CPU 32 determines whether the user authentication using the user authentication information included in the received scan instruction succeeds or not. The CPU 32 acquires the management ID stored in the management table 44 in association with said user authentication information as the target management ID in response to the user authentication being successful. In this case, the CPU 32 acquires the target management ID as the target management ID. In this case, the CPU 32 determines that the target management ID can be acquired (YES in S10) and proceeds to S20. Contrary to this, in a case where the user authentication does not succeed, the CPU 32 determines that the target management ID cannot be acquired (NO in S10) and proceeds to S12.

In S12, the CPU 32 sends an error notification to the target terminal device. In this case, the error notification includes information indicating that user authentication has failed.

In S20, the CPU 32 generates a new JobID and stores the generated JobID in the management table 44 in association with the target management ID.

In S22, the CPU 32 generates a URI including location information of the scanner 10 (https://server.com) and the JobID, and sends the generated URI to the first target terminal device. According to this configuration, the first target terminal device can know where to send the image request and the cancellation request described below.

In S30, the CPU 32 monitors receipt of the image request from the second target terminal device. The image request is a signal to request generation of the scan image data corresponding to the target JobID included in the URI in the image request. The image request includes the URI sent in S22 as its destination. The image request also includes the user authentication information. In a case where the CPU 32 receives the image request from the second target terminal device, the CPU 32 determines YES in S30 and proceeds to S32. The second target terminal device may be the same as or different from the first target terminal device.

In S32, the CPU 32 determines whether the management ID corresponding to the second target terminal device (hereinafter referred to as “first comparison management ID”) can be acquired or not. Specifically, the CPU 32 determines whether the user authentication using the user authentication information included in the received image request succeeds or not. The CPU 32 acquires the management ID stored in the management table 44 in association with said user authentication information as the first comparison management ID. In this case, the CPU 32 determines that the first comparison management ID can be acquired (YES in S32) and proceeds to S34. Contrary to this, the CPU 32 determines that the first comparison management ID cannot be acquired in a case where the user authentication does not succeed (NO in S32), and proceeds to S50.

In S34, the CPU 32 determines whether the target management ID and the first comparison management ID match. The CPU 32 proceeds to S36 in a case where the target management ID and the first comparison management ID match (YES in S34). Contrary to this, the CPU 32 proceeds to S50 in a case where the target management ID and the first comparison management ID do not match (NO in S34).

In S36, the CPU 32 acquires image data acquired by causing the scan executing unit 18 to scan a document (document scanning). Next, the CPU 32 generates scan image data (hereinafter described as “target scan image data”) by converting the acquired image data to a predetermined format (e.g., JPEG). The CPU 32 also stores the target scan image data in the management table 44 in association with the target management ID.

In S38, the CPU 32 sends a first completion notification to the second target terminal device. The first completion notification includes information indicating that generation of the target scan image data is completed.

In S40, the CPU 32 receives an image data request from the second target terminal device. The image data request includes the user authentication information. The image data request is a signal to request the scanner 10 to send the target scan image data.

In S42, the CPU 32 specifies the target scan image data stored in the management table 44 in association with the user authentication information included in the image data request, and sends the target scan image data to the second target terminal device. The CPU 32 ends the processes in FIG. 4 when S42 ends.

In S50, the CPU 32 sends an error notification to the second target terminal device. The error notification after NO in S32 includes information indicating that the user authentication has failed. The error notification after NO in S34 includes information indicating that the document scanning cannot be executed. The CPU 32 returns to S30 when S50 ends.

Concurrently with the monitoring of S30, in S60, the CPU 32 monitors receipt of a cancellation request from the third target terminal device. The cancellation request is a signal to cancel the document scanning. The cancellation request includes the URI sent in S22 as its destination. The cancellation request also includes the user authentication information. In a case where the CPU 32 receives the cancellation request from the third target terminal device, the CPU 32 determines YES in S60 and proceeds to S62. The third target terminal device may be the same as or different from the first target terminal device.

In S62, the CPU 32 determines whether a management ID corresponding to the third target terminal device (hereinafter described as “second comparison management ID”) can be acquired or not. Specifically, the CPU 32 determines whether the user authentication using the user authentication information included in the received cancellation request succeeds or not. The CPU 32 acquires the management ID stored in the management table 44 in association with said user authentication information as the second comparison management ID. In this case, the CPU 32 determines that the second comparison management ID can be acquired (YES in S62) and proceeds to S64. Contrary to this, the CPU 32 determines that the second comparison management ID cannot be acquired in a case where the user authentication does not succeed (NO in S62) and proceeds to S50.

S64 is the same as S34 except that the second comparison management ID is used. The CPU 32 proceeds to S66 in a case where YES is determined in S64, and proceeds to S50 in a case where NO is determined in S64.

In S66, the CPU 32 executes a cancellation process to cancel the document scanning. Specifically, the CPU 32 deletes the JobID in the URI included in the cancellation request received in S60 from the management table 44.

In S68, the CPU 32 sends a second completion notification to the second target terminal device. The second completion notification includes information indicating that the document scanning has been canceled. The CPU 32 ends the processes in FIG. 4 when S68 ends.

In S50 after NO in S62 or NO in S64, the CPU 32 sends an error notification to the third target terminal device. The error notification after NO in S62 includes information indicating that the user authentication has failed. The error notification after NO in S64 includes information indicating that the document scanning cannot be canceled.

### Specific Cases

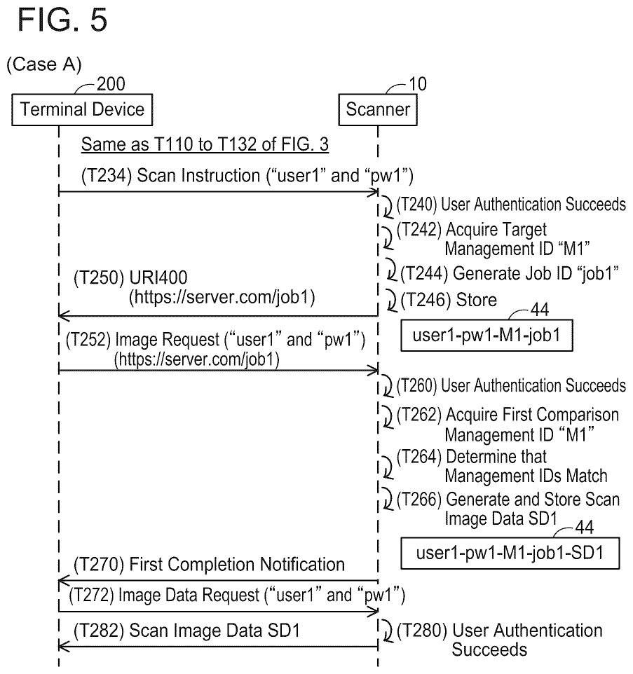

With reference to FIGS. 5 to 7, specific cases realized by the communication system 2 in the present embodiment will be described.

### Case A; FIG. 5

With reference to FIG. 5, Case A in which scan image data SD1 is sent to the terminal device 200 will be described. An initial state of Case A is the same as the initial state in FIG. 3.

Firstly, the same processes as T110 to T132 in FIG. 3 are executed between the scanner 10 and the terminal device 200. In this case, in T234 the terminal device 200 sends a scan instruction including the user name “user1” and the password “pw1” to the scanner 10.

When the scanner 10 receives the scan instruction from the terminal device 200 in T234, in T240 the scanner 10 determines that the user authentication has succeeded in T240 because the user name “user1” and the password “pw1” in the scan instruction are stored in the management table 44, and, in T242, acquires the management ID “M1” stored in association with the user name “user1” and the password “pw1” as the target management ID “M1”. In this case, the scanner 10 determines that the target management ID can be acquired (YES in S10 of FIG. 4). Next, in T244, the scanner 10 generates a JobID “job1”, and, in T246, stores the JobID “job1” in association with the target management ID “M1” in the management table 44 (S20). Next, the scanner 10 generates a URI 400 (https://server.com/job1) including the location information of the scanner 10 (https://server.com) and the JobID “job1”, and, in T250, sends the URI 400 to the terminal device 200 (S22).

When the terminal device 200 receives the URI 400 from the scanner 10 in T250, the terminal device 200 acquires the user name “user1” and the password “pw1” in the primary storage device of the memory of the terminal device 200, and, in T252, sends the image request including the user name “user1” and the password “pw1” to the URI 400 as its destination.

In T252, the scanner 10 receives the image request from the terminal device 200 (YES in S30). T260 is the same as T240. In T262, the scanner 10 acquires the management ID “M1” stored in association with the user name “user1” and the password “pw1” as the first comparison management ID “M1”. In this case, the scanner 10 determines that the first comparison management ID can be acquired (YES in S32). Next, in T264, the scanner 10 determines that the target management ID “M1” and the first comparison management ID “M1” match (YES in S34), and, in T266, generates the scan image data SD1 and stores the scan image data SD1 in association with the target management ID “M1” in the management table 44 (S36). Due to this, the user name “user1”, the password “pw1”, the management ID “M1”, the Job ID “job1”, and the scan image data SD1 are stored in association with each other in the management table 44. Next, in T270, the scanner 10 sends the first completion notification to the terminal device 200.

When the terminal device 200 receives the first completion notification from the scanner 10 in T270, the terminal device 200 acquires the user name “user1” and the password “pw1” in the primary storage device of the memory of the terminal device 200, and, in T272, sends an image data request including the user name “user1” and the password “pw1” to the scanner 10.

T280 is the same as T240. In this case, the scanner 10 specifies the scan image data SD1 stored in the management table 44 in association with the user name “user1” and the password “pw1” included in the image data request, and, in T282, sends the scan image data SD1 to the terminal device 200. As such, the scan image data SD1 is sent to the terminal device 200.

### Effects of Case A

As described above, the scanner 10 specifies the management ID corresponding to the scan instruction by using the user authentication information (i.e., user name “user1” and password “pw1”) included in the scan instruction received from the terminal device 200. According to this configuration, the management ID corresponding to the scan instruction can be properly specified.

In the case where the terminal device 200 receives the scan execution operation (T132 in FIG. 3) to send the scan instruction to the scanner 10, even when the user authentication information is not inputted by the user, the terminal device 200 sends the scan instruction including the user authentication information stored in the terminal device 200 (that is, user name “user1” and password “pw 1”) to the scanner (T234). Thus, user convenience is improved.

According to the above configuration, in the case where the user authentication succeeds (T126 in FIG. 3), the scanner 10 receives the scan instruction including the user authentication information from the terminal device 200 (T234). According to this configuration, the number of user(s) who can use the scan function can be restricted.

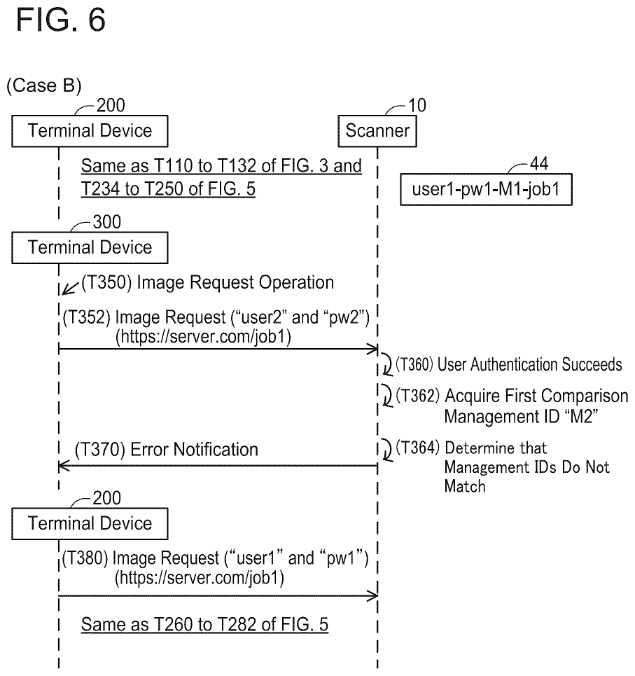

### Case B; FIG. 6

With reference to FIG. 6, Case B in which the scan image data SD1 is sent to the terminal device 200 will be described. An initial state of Case B is the same as the initial state of Case A in FIG. 5.

Firstly, the same processes as T110 to T132 in FIGS. 3 and T234 to T250 in FIG. 5 are executed between the scanner 10 and the terminal device 200. In this case, we assume a situation where the URI 400 is acquired by the terminal device 300 different from the terminal device 200 that sent the scan instruction. A user of the terminal device 300 has already performed an operation of inputting the user name “user2” and the password “pw2” into the terminal device 300. Therefore, the user name “user2” and the password “pw2” are stored in the primary storage device of the memory of the terminal device 300. In T350, the user of the terminal device 300 performs an image request operation on the terminal device 300. Due to this, the terminal device 300 acquires the user name “user2” and the password “pw2” in the primary storage device of the memory of the terminal device 300, and, in T352, sends an image request including the user name “user2” and the password “pw2” to the scanner 10 with the URI 400 as its destination.

When the scanner 10 receives the image request from the terminal device 300 in T352 (YES in S30), in T360 the scanner 10 determines that the user authentication has succeeded because the user name “user2” and the password “pw2” in the image request are stored in the management table 44, and, in T362, acquires the management ID “M2” stored in association with the user name “user2” and the password “pw2” as the first comparison management ID “M2”. In this case, the scanner 10 determines that the first comparison management ID “M2” can be acquired (YES in S32). Next, in T364, the scanner 10 determines that the target management ID “M1” and the first comparison management ID “M2” do not match (NO in S34), and, in T370, sends an error notification including information indicating that the document scanning cannot be executed to the terminal device 300 (S50).

In subsequent T380, the terminal device 200 sends the image request including the user name “user1” and the password “pw1” with the URI 400 as its destination. Due to this, the same processes as T260 to T282 in FIG. 5 are executed between the scanner 10 and the terminal device 200.

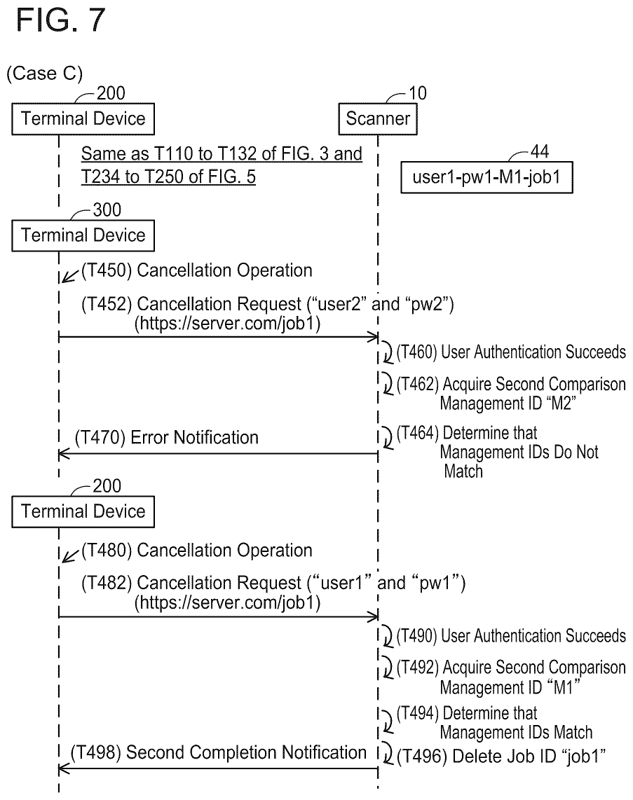

### Case C; FIG. 7

With reference to FIG. 7, Case C in which the document scanning is canceled will be described. An initial state of Case C is the same as the initial state of Case A in FIG. 5.

Firstly, the same processes as T110 to T132 in FIGS. 3 and T234 to T250 in FIG. 5 are executed between the scanner 10 and the terminal device 200. In this case, we assume a situation where the URI 400 is acquired by the terminal device 300, similar to Case B in FIG. 6. In T450, the user of the terminal device 300 performs a cancellation operation, on the terminal device 300, to cancel the document scanning. Due to this, the terminal device 300 acquires the user name “user2” and the password “pw2” in the primary storage device of the memory of the terminal device 300, and in T452, sends a cancellation request including the user name “user2” and the password “pw2” to the URI 400 as its destination.

When the scanner 10 receives the cancellation request from the terminal device 300 in T452 (YES in S60), in T460 the scanner 10 determines that the user authentication has succeeded because the user name “user2” and the password “pw2” in the cancellation request are stored in the management table 44, and, in T462, acquires the management ID “M2” stored in association with the user name “user2” and the password “pw2” as the second comparison management ID. In this case, the scanner 10 determines that the second comparison management ID can be acquired (YES in S62). Next, in T464, the scanner 10 determines that the target management ID “M1” and the second comparison management ID “M2” do not match (NO in S64), and, in T470, sends an error notification including information indicating that the document scanning cannot be canceled to the terminal device 300 (S50).

In subsequent T480, the user of the terminal device 200 performs the cancellation operation on the terminal device 200. Due to this, the terminal device 200 acquires the user name “user1” and the password “pw1” in the primary storage device of the memory of the terminal device 200, and in T482, sends a cancellation request including the user name “user1” and the password “pw1” to the scanner 10 with the URI 400 as its destination.

When the scanner 10 receives the cancellation request from the terminal device 200 in T482 (YES in S60), in T490 the scanner 10 determines that the user authentication has succeeded because the user name “user1” and the password “pw1” in the cancellation request are stored in the management table 44, and, in T492, acquires the management ID “M1” stored in association with the user name “user1” and the password “pw1” as the second comparison management ID. In this case, the scanner 10 determines that the second comparison management ID can be acquired (YES in S62). Next, in T494, the scanner 10 determines that the target management ID “M1” and the second comparison management ID “M1” match (YES in S64), and, in T496, executes the cancellation process to delete the Job ID “job1” from the management table 44 (S66). Next, in T498, the scanner 10 sends a second completion notification including information indicating that the document scanning has been canceled to the terminal device 200 (S68). In this way, the document scanning is canceled.

### Effect of Case C

As described above, the scanner 10 executes the cancellation process in the case where the cancellation request is received and the target management ID corresponding to the scan instruction and the second comparison management ID corresponding to the cancellation request match (T494). Contrary to this, the scanner 10 does not perform the cancellation process in the case where the cancellation request is received and the target management ID and the second comparison management ID do not match (T464). According to this configuration, the scanner 10 can properly execute the cancellation process. Specifically, the scanner 10 can execute the cancellation process only when the document scanning is cancelled by the user who desired to execute the scanning.

### Effects of Present Embodiment

According to the above configuration, the scanner 10 sends the scan image data to the second target terminal device (S40) in the case where the target management ID corresponding to the scan instruction and the first comparison management ID corresponding to the image request match (YES in S34 in FIG. 4). In the case where the target management ID and the first comparison management ID match, it is highly likely that the first target terminal device, which is the sender of the scan instruction, and the second target terminal device, which is the sender of the image request, are the same. Therefore, the scanner 10 can properly send the scan image data. Specifically, the scanner 10 can send the scan image data to the user who desired to execute the scanning. Contrary to this, the scanner 10 does not send the scan image data to the second target terminal device in the case where the target management ID and the first comparison management ID do not match (NO in S34). In the case where the target management ID and the first comparison management ID do not match, it is highly likely that the first target terminal device, which is the sender of the scan instruction, and the second target terminal device, which is the sender of the image request, are different. Therefore, it is possible to suppress the scan image data from being sent to a terminal device that is not the sender of the scan instruction.

### Correspondence Relationships

The terminal device 200 is an example of “first terminal device”. The management ID corresponding to the user authentication information included in the scan instruction is an example of “first user identification information”. The terminal devices 200 and 300 are examples of “second terminal device”. The management ID corresponding to the user authentication information included in the image request is an example of “second user identification information”. The terminal devices 200 and 300 are examples of “third terminal device”. The management ID corresponding to the user authentication information included in the cancellation request is an example of “third user identification information”. The user authentication information included in the scan instruction is an example of “first user authentication information”. The user authentication information included in the image request is an example of “second user authentication information”. The terminal device 100 is an example of “fourth terminal device”. The user name “user1” and the password “pw1” are examples of “specific user authentication information”. The management ID “M1” is an example of “specific user identification information”. The user name “user2” and the password “pw2” are examples of “specific user authentication information”. The management ID “M2” is an example of “specific user identification information”. The scan execution operation of T132 in FIG. 3 is an example of “first operation”. The scan execution operation of T132 in FIG. 3 and the image request operation of T350 in FIG. 6 are examples of “second operation”.

S36 in FIG. 4 is an example of a process executed by “cause the scan executing unit to scan a document and acquire scan image data”. S10 in FIG. 4 is an example of a process executed by “acquire first user identification information”. S30 in FIG. 4 is an example of a process executed by “receive an image request”. S32 in FIG. 4 is an example of a process executed by “acquire second user identification information”. S42 in FIG. 4 is an example of a process executed by “send the scan image data”.

(First Modification) S60 to S68 in FIG. 4 can be omitted. In this modification, “receive a cancellation request”, “acquire third user identification information”, and “execute a process for cancelling scanning of the document” can be omitted. In another modification, S62 and S64 can be omitted. In this modification, “receive a cancellation request” can be omitted.

(Second Modification) In the embodiment, the scanner 10 generates a management ID and stores the generated management ID in the management table 44 in the registration process in FIG. 2. In a modification, the management table 44 may not include the management ID. In this modification, each of the terminal devices 200 and 300 stores the management IDs “M1” and “M2”. In this case, the scan instruction, the image request, the image data request, and the cancellation request include the management ID stored in the terminal device which is the sender of each signal. Due to this, the scanner 10 can acquire the management ID in response to receiving the scan instruction, the image request, the image data request, or the cancellation request.

(Third Modification) In the embodiment, the scanner 10 generates a management ID and stores the generated management ID in the management table 44 in the registration process in FIG. 2. In a modification, the management table 44 may not include the management ID. In this modification, each time the scanner 10 receives a signal including the user authentication information (e.g., scan instruction, image request, image data request, cancellation request), the scanner 10 generates and acquires a management ID by using the user authentication information included in that signal. In this modification, if the same user authentication information is used, the same management ID is generated regardless of when the management ID is generated. For example, when the scan instruction is received, the scanner 10 generates and acquires the target management ID by using the user authentication information included in the scan instruction. The scanner 10 can use the same method to acquire the first and second comparison management IDs. In this modification, “generate specific user identification information”, “store the specific user authentication information and the specific user identification information” can be omitted.

(Fourth Modification) The terminal device 200 may send the signals (scan instruction, image request, image data request, and cancellation request) including the user name “user1” and the password “pw1” to the scanner 10 in response to receiving an input of the user name “user1” and the password “pw1”. In this modification, T125 in FIG. 3 can be omitted.

(Fifth Modification) In each of the above embodiments, the processes in FIGS. 2 to 7 are realized by software (e.g., programs 40 and 140), but at least one of these processes may be realized by hardware such as a logic circuitry.

What is claimed is:

1. A scanner comprising:
a scan executing unit; and
a controller configured to:
receive a scan instruction from a first terminal device;
in a case where the scan instruction is received from the first terminal device, cause the scan executing unit to scan a document and acquire scan image data;
in the case where the scan instruction is received from the first terminal device, acquire first user identification information corresponding to the scan instruction;
after the scan instruction has been received from the first terminal device, receive an image request from a second terminal device;
in a case where the image request is received from the second terminal device, acquire second user identification information corresponding to the image request; and
in a case where the first user identification information and the second user identification information match, send the scan image data to the second terminal device.

2. The scanner according to claim 1, wherein the controller is further configured to:
in the case where the scan instruction is received from the first terminal device, send position information of the scanner to the first terminal device,
wherein the second terminal device is configured to send the image request to the scanner by using the position information.

3. The scanner according to claim 1, wherein the controller is further configured to:
after the scan instruction has been received from the first terminal device, receive a cancellation request from a third terminal device;
in a case where the cancellation request is received from the third terminal device, acquire third user identification information corresponding to the cancellation request; and
in a case where the first user identification information and the third user identification information match, execute a process for cancelling scanning of the document.

4. The scanner according to claim 1, further comprising a memory configured to store, for each of one or more user authentication information, the user authentication information and user identification information in association with each other,
wherein the scan instruction includes first user authentication information, and
the image request includes second user authentication information,
wherein the controller is configured to:
acquire the first user identification information stored in the memory in association with the first user authentication information included in the scan instruction; and
acquire the second user identification information stored in the memory in association with the second user authentication information included in the image request.

5. The scanner according to claim 4, wherein the controller is further configured to:
in a case where a registration instruction including specific user authentication information is received from a fourth terminal device, generate specific user identification information corresponding to the specific user authentication information; and
in a case where the specific user identification information is generated, store the specific user authentication information and the specific user identification information in the memory in association with each other.

6. The scanner according to claim 4, wherein the first terminal device is configured to, in a case where a first operation to send the scan instruction to the scanner is received, send the scan instruction including the first user authentication information stored in the first terminal device to the scanner even when the first user authentication information is not inputted by a user, and
the second terminal device is configured to, in a case where a second operation to send the image request to the scanner is received, send the image request including the second user authentication information stored in the second terminal device to the scanner even when the second user authentication information is not inputted by a user.

7. The scanner according to claim 4, wherein the controller is further configured to:
send authentication screen data representing an authentication screen for inputting user authentication information to the first terminal device, wherein the first terminal device is configured to, in a case where the authentication screen data is received from the scanner, display the authentication screen;
in response to the first user authentication information being inputted on the authentication screen, receive the first user authentication information from the first terminal device, and
in a case where the received first user authentication information is stored in the memory, send, to the first terminal device, success information indicating that user authentication has succeeded,
wherein the first terminal device is configured to, in a case where the success information is received from the scanner, display a scan instruction screen for receiving a first operation to send the scan instruction to the scanner,
wherein the controller is configured to, in response to the first operation being received on the scan instruction screen, receive the scan instruction including the first user authentication information from the first terminal device.

8. A non-transitory computer-readable recording medium storing computer-readable instructions for a scanner comprising a processor:
wherein the computer-readable instructions, when executed by the processor, cause the scanner to:
receive a scan instruction from a first terminal device;
in a case where the scan instruction is received from the first terminal device, cause a scan executing unit of the scanner to scan a document and acquire scan image data;
in the case where the scan instruction is received from the first terminal device, acquire first user identification information corresponding to the scan instruction;
after the scan instruction has been received from the first terminal device, receive an image request from a second terminal device;
in a case where the image request is received from the second terminal device, acquire second user identification information corresponding to the image request; and
in a case where the first user identification information and the second user identification information match, send the scan image data to the second terminal device.

9. A method executed by a scanner, the method comprising:
receiving a scan instruction from a first terminal device;
in a case where the scan instruction is received from the first terminal device, causing a scan executing unit of the scanner to scan a document and acquiring scan image data;
in the case where the scan instruction is received from the first terminal device, acquiring first user identification information corresponding to the scan instruction;
after the scan instruction has been received from the first terminal device, receiving an image request from a second terminal device;
in a case where the image request is received from the second terminal device, acquiring second user identification information corresponding to the image request; and
in a case where the first user identification information and the second user identification information match, sending the scan image data to the second terminal device.
